(19) United States
(12) Patent Application Publication
(10) Pub. No.: US 2026/0134383 A1
(43) Pub. Date: May 14, 2026

(54) TRANSPORTATION OPTIMIZATION

(71) Applicant: Certu Systems, Inc., Pittsburgh, PA (US)

(72) Inventor: Hyong Sok Kim, Pittsburgh, PA (US)

(21) Appl. No.: 18/947,887

(22) Filed: Nov. 14, 2024

(51) Int. Cl. G06Q 10/0835; G06Q 10/047; G06Q 10/0631; G06Q 10/087

(52) U.S. Cl. CPC G06Q 10/08355; G06Q 10/047; G06Q 10/06311; G06Q 10/087

(57) ABSTRACT

One embodiment provides a method, the method including: receiving a transportation request, wherein the transportation request identifies a transportation object, an amount of the transportation object that needs transported, and a destination location for the transportation object; determining, using an optimization model and based upon transportation constraints and inventory constraints, a schedule for transporting the transportation object to the destination location, wherein the schedule identifies at least one transporter to perform the transporting and identifies at least one origin location for the transportation object; and generating a transportation order including the amount of the transportation object, the destination location, and the schedule. Other aspects are claimed and described.

### BACKGROUND

Logistics is the process of managing how objects are obtained, stored, and transported to a final destination of the object. The transportation of objects includes transportation from a manufacturing facility to a destination where objects might be utilized by different companies or entities. The transportation also includes storing objects within warehouses until a final destination is identified. The warehouses provide a buffer for the storage of objects that can immediately fulfill a demand while new quantities of the object are manufactured. Thus, an entity may be able to order and object and receive it within a short period of time as opposed to having to wait until the object is manufactured. To get objects from one location to another, for example, from a manufacturing location to a warehouse, from a warehouse to another warehouse, from a warehouse to a final destination, and/or the like, different transportation modes may be utilized. Different transportation modes may include boats, airplanes, trucks, and/or the like. These transportation modes allow for the transportation of many different goods at the same time, which is particularly useful for the movement of large amounts of objects from one location to another.

### BRIEF SUMMARY

In summary, one aspect provides a method, the method including: receiving a transportation request, wherein the transportation request identifies a transportation object, an amount of the transportation object that needs transported, and a destination location for the transportation object; determining, using an optimization model and based upon transportation constraints and inventory constraints, a schedule for transporting the transportation object to the destination location, wherein the schedule identifies at least one transporter to perform the transporting and identifies at least one origin location for the transportation object; and generating a transportation order including the amount of the transportation object, the destination location, and the schedule.

Another aspect provides a system, the system including: a processor; a memory device that stores instructions that, when executed by the processor, causes the system to: receive a transportation request, wherein the transportation request identifies a transportation object, an amount of the transportation object that needs transported, and a destination location for the transportation object; determine, using an optimization model and based upon transportation constraints and inventory constraints, a schedule for transporting the transportation object to the destination location, wherein the schedule identifies at least one transporter to perform the transporting and identifies at least one origin location for the transportation object; and generate a transportation order including the amount of the transportation object, the destination location, and the schedule.

A further aspect provides a product, the product including: a computer-readable storage device that stores executable code that, when executed by a processor, causes the product to: receive a transportation request, wherein the transportation request identifies a transportation object, an amount of the transportation object that needs transported, and a destination location for the transportation object; determine, using an optimization model and based upon transportation constraints and inventory constraints, a schedule for transporting the transportation object to the destination location, wherein the schedule identifies at least one transporter to perform the transporting and identifies at least one origin location for the transportation object; and generate a transportation order including the amount of the transportation object, the destination location, and the schedule.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example device.

FIG. 2 illustrates an example method for generating a transportation order for transporting a transportation object including a schedule generated utilizing an optimization model.

### DETAILED DESCRIPTION

When moving objects from one location to another, transportation modes are selected and then dispatched to pick up the objects and deliver them to the desired location. The transportation of the objects may be responsive to receiving a transportation request which identifies what objects are to be moved and to where they are to be moved. Traditional transportation requests also include an origin location indicating where the objects should be picked up. The function of identifying and scheduling a transporter, or transporters, to move the objects requires identifying where the objects are to be picked up from, which transporter is to be used to transport the objects, and identifying the destination location. Generally, companies utilize logistic companies that are responsible for transporting different objects for the company. The logistic company then assigns a specific transporter for the actual transportation of the object from one location to another.

Generally, the transporter is selected based upon an origin location of the objects. Specifically, the logistic company may have transportation groups, where each group is generally responsible for a certain area or region and those origin locations which fall within that area or region are assigned to that transportation group. The transporter that is chosen is generally selected based upon availability with respect to a time when the objects need to be picked up and delivered. Other factors may influence the choice of the transporter, for example, seniority, transporter requests, and/or the like. However, this entire process is generally a manual process performed by dispatchers. The dispatchers identify the origin location, a time frame for the delivery, the destination location, and schedules of the potential transporters. The dispatcher then identify which transporter should perform the transportation and assigns the transporter to the route and provides the order to the transporter. Not only is this a manual process, but it relies on identification of the origin location, destination location, and delivery schedule as provided within the transportation request. Thus, such a process does not take into account factors or constraints that may cause a resulting route and schedule for the transportation of the objects to be inefficient, from both a time and money perspective.

Accordingly, the described system and method provides a technique for generating a transportation order for transporting a transportation object including a schedule generated utilizing an optimization model. The transportation optimization system receives a transportation request that identifies a transportation object and an amount of the transportation object that needs to be transported. Additionally, the transportation request identifies a destination location for the transportation object. The transportation request may also identify other information, for example, a time frame for when the transportation object needs to be delivered, an origin location, restrictions for transporting the object, and/or the like.

The system determines, using an optimization model, a schedule for transporting the transportation object to the destination location. The optimization model may be a rules engine, an artificial intelligence model, and/or the like, or a combination thereof. The schedule identifies at least one transporter to perform the transporting and also identifies at least one origin location for the transportation object. While the transportation request may identify an origin location, the system may ignore that origin location and instead identify which origin location, from a plurality of possible origin locations, should be used to obtain the transportation object. This allows the system to take into account transportation constraints and inventory constraints to determine which origin location would result in the most efficient or optimized schedule for getting the desired transportation object to the desired destination location. The schedule may also identify when the object should be picked up, the type of transportation mode that should be utilized, the route that should be used by the transporter, and/or the like. Once the schedule is determined, the system may generate a transportation order to be given to the selected transporter and that identifies the transportation object, the amount of the transportation object to be obtained, the destination location, and the schedule that identifies the origin location.

Therefore, a system provides a technical improvement over traditional methods for generating transportation orders. The described transportation optimization system is able to identify an origin location for a transportation object, instead of being tied to a particular origin location. Thus, the system is able to identify which origin location is the best origin location for obtaining the transportation object based upon both transportation constraints and inventory constraints. This allows the system to identify which origin location may result in the most efficient schedule, route, and inventory use out of the possible origin locations, instead of being tied to a particular origin location as in conventional techniques where the origin location is specifically identified within the transportation request. Additionally, the described system is more automated than the traditional techniques, which results in more accurate scheduling of transportation orders than conventional systems. Thus, the described transportation optimization system is more efficient, from both a time and money perspective, than traditional transportation order generation.

The illustrated example embodiments will be best understood by reference to the figures. The following description is intended only by way of example, and simply illustrates certain example embodiments.

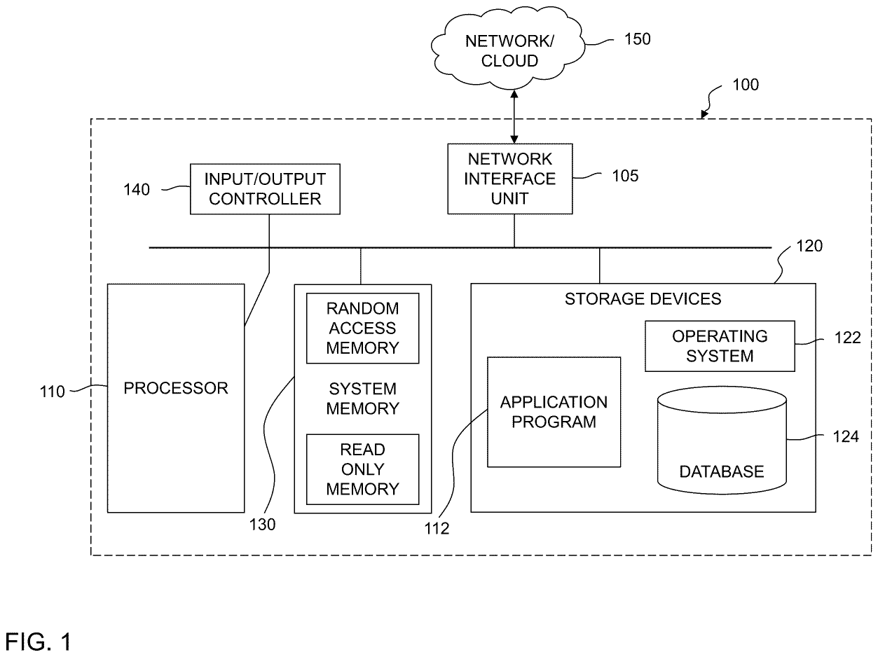

While various other circuits, circuitry or components may be utilized in the described system, an example is illustrated in FIG. 1. In the example of FIG. 1, storage devices 120 includes software such as a workflow graphical user interface application program 112 that may be run or executed by processor(s) 110 according to an operating system 122. The circuitry 100 provides that the processor 110 loads the operating system 122 and thereafter the application program 112, e.g., into memory 130.

System 100 typically includes a network interface 105 facilitating communications with other devices, e.g., a connection to other devices over a network 150 (which may include a local network, remote network, cloud network, etc.) using components such as a WWAN transceiver, a WLAN transceiver or a wired connection, e.g., a LAN connection. Commonly, system 100 will include an input/output controller 140 for data input and display. System 100 typically includes various memory 130 and storage devices 120, for example a database 124, e.g., for storing data from internal and external data sources, referred to herein.

Device circuitry, as for example outlined in FIG. 1, may be used to generate, manage, and process data collected during the operation of the program providing a graphical user interface for workflow. It will also be apparent that circuitry other than the non-limiting example outlined in FIG. 1 may be used.

Information handling device circuitry, as for example outlined in FIG. 1, may be used in devices such as tablets, smart phones, personal computer devices generally, electronic devices, and/or the like, that may interface with the transportation optimization engine, be a part of the transportation optimization engine, and/or utilized by users, including transporters, to access information provided within or by the transportation optimization system.

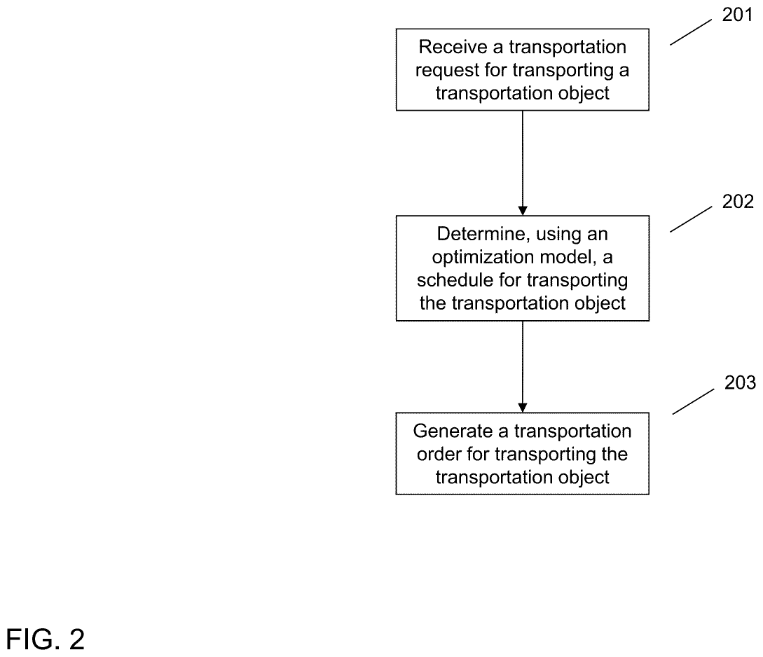

FIG. 2 illustrates an example method for generating a transportation order for transporting a transportation object including a schedule generated utilizing an optimization model. The method may be implemented on a system which includes a processor, memory device, output devices (e.g., display device, etc.), input devices (e.g., keyboard, touch screen, mouse, microphones, sensors, biometric scanners, etc.), image capture devices, and/or other components. While the system may include known hardware and software components and/or hardware and software components developed in the future, the system itself is specifically programmed to perform the functions as described herein to generate a transportation order for transporting a transportation object. Additionally, the transportation optimization system includes modules and features that are unique to the described system.

The transportation optimization system may be utilized to optimize a transportation route and schedule for transporting transportation objects or goods to a destination location. In order to utilize the transportation optimization system, the system may be activated, either as a standalone application, as a module that works with another application, and/or the like, or a combination thereof. The system may be automatically activated by an application that provides instructions to the system or may be manually activated by a user providing input to the system. The automatic activation of the transportation optimization system may be based upon the detection of a trigger event indicating that the system should be activated. Example trigger events include receipt of a transportation request, identification of multiple origin locations for a transportation object, activation of software or an application utilizing the transportation optimization system, and/or the like.

The transportation optimization system may be made of multiple systems or modules that communicate together to make up the transportation optimization system or may be a single system. The transportation optimization system may be a system within an organization, for example, a logistics organization, a supplier, and/or any other organization that may arrange transport of objects. The transportation optimization system may communicate with other systems within the organization and may also communicate with other systems outside the organization, for example, systems of other entities that may transmit transportation requests, for example, organizations that want transportation objects transported, inventory control organizations, transportation request generation organizations, and/or the like. Thus, the transportation optimization system may include components or modules that allow for the communication between the transportation optimization system and the internal and/or external systems. These components or modules may be all located on a single computing device or single computing system, or different components or modules of the system could be located across multiple computing devices or multiple computing system.

The transportation optimization system may be a standalone system, may be accessible through other computing devices, and/or a combination thereof. For example, the transportation optimization system may be a standalone system that can be accessed by a user and/or may be or provide an application that is accessible by a user on another computing device. The transportation optimization system may be accessible using any type of computing device, for example, personal computer, laptop computer, smartphone, tablet, smartwatch, head-mounted display, smart television or other smart appliance, augmented reality device, virtual reality device, and/or the like. Thus, the transportation optimization system may be accessible locally using a computing device where the transportation optimization system is installed and/or may be accessible remotely through another computing device. For example, the transportation optimization system may be accessed by a user using a device that communicates with the transportation optimization system to provide instructions for generating transportation orders, determining a schedule for transporting a transportation object, and/or the like.

However, the transportation optimization system may be located and operate on a different information handling device to perform the described steps. For example, the transportation optimization system may be located and operate on a cloud computing device, a computing device accessed through a remote network, a computing device accessed through a local network, and/or the like, or a combination thereof.

The transportation optimization system may have an associated graphical user interface. The graphical user interface may be provided on a display or monitor, which may or may not be associated with the transportation optimization system. In other words, the transportation optimization system may have a dedicated display or monitor or may be accessible using any display or monitor. In either case, the transportation optimization system may provide instructions to generate and display the graphical user interface on the display device being used to access the transportation optimization system. The graphical user interface may also be updated and managed based upon instructions provided by the transportation optimization system. In other words, the transportation optimization system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the transportation optimization system. For example, the transportation optimization system may utilize, historical information, transporter information, origin location information, destination location information, inventory information, and/or the like, to process a transportation request, determine a schedule for transporting a transportation object, optimizing a route and schedule for the transportation of a transportation object, generating a transportation order, and/or the like. The graphical user interface may allow for creation of or access to these profiles, historical information, and/or the like, by allowing a user to input information regarding the locations, schedules, information, and/or the like. As will be discussed in more detail, the use of user provided information is not the only way that the historical information, transporter information, location information, and/or the like, can be created. The transportation optimization system can then utilize these inputs to store the historical information, determine a schedule, optimize a route and schedule, and/or the like.

A user could also use the graphical user interface to adjust information stored within the system, make changes to generated transportation orders or information utilized to generate the transportation order, provide input indicating a transportation order should be generated, access information utilized to generate the transportation order, and/or the like. Additionally, or alternatively, the user can input a location of information related to the information, provide a file corresponding to the information or portion thereof, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display different information that is utilized by the system, output by the system, generated by the system, and/or the like. It should be noted that the information to be used by the transportation optimization system and information provided by the transportation optimization system can be different for different applications, different computing systems, different users, and/or the like. Thus, the information corresponding to input or output of the transportation optimization system are not always the same. However, the transportation optimization system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The transportation optimization system may utilize one or more artificial intelligence models in determining a schedule, optimizing the schedule and route, generating a transportation order, and/or any other steps included in the system or method. Artificial intelligence models may also be used for steps within a step. For example, a model could be utilized to optimize a schedule and route in determining a schedule for transporting the transportation object to a destination location, analyze transporters schedule and preferences to determine a schedule, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the transportation optimization system or may be a model that is created from scratch. Since the transportation optimization system is used in conjunction with generating a transportation order from a received transportation request, some models that may be utilized by the system are text analysis models, image analysis models, other analysis models, optimization models, similarity identification models, large language models, language models, filtering models, classification models, mapping models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like. The ingesting of feedback may be automatic or manual and may be dependent upon the type of feedback and the deployment mode (e.g., training, deployed, testing, etc.) of the artificial intelligence model.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The transportation optimization system may include different components for carrying out different functions of the system, including different steps to be performed. These components may be hardware components or software components.

Some hardware devices or components that may be utilized by the transportation optimization system include input devices that may be utilized to receive input from the user, for example, mechanical input modalities (e.g., keyboard, mouse, etc.), touch input devices, gesture input devices, electromyography input devices, audio input devices, biometric input devices, and/or the like. Other hardware components may be utilized to provide output from the transportation optimization system. For example, the transportation optimization system may include speakers, displays or monitors, haptic output devices, audio output devices, and/or the like. Other hardware components may include data storage devices, including on devices of the user (e.g., mobile device, personal computer, laptop, tablet, smart watch, etc.), devices or components of the transportation optimization system, and/or the like.

One software component that may be utilized are profiles. These profiles may be associated with particular transportation customers or entities whose products or goods are being transported, origin locations, destination locations, particular transporters, and/or the like. The profiles may include preferences of an entity associated with the profile, requirements or restrictions of an entity associated with the profile, schedules of an entity associated with the profile, regulations that may be associated with an entity, information related to inventories of transportation objects, and/or the like. For example, a transportation customer profile may identify preferences of the customers who are requesting a particular transportation object. These preferences might include, but are not limited to, a preferred delivery schedule, preferred transporters, destination locations, a preferred frequency of delivery, any restrictions (e.g., restrictions regarding other objects that can be co-located on transportation vehicle with the object, regulations applicable to particular objects, how quickly objects need to be delivered, etc.), and/or the like.

For example, a profile associated with an origin location may identify hours of operation, hours that goods or transportation objects can be picked up (e.g., only during business hours, only after hours, a subset of business hours, a range of hours, certain days, etc.), types and sizes of trucks or transportation vehicles that can access the origin location, equipment available for use at the origin location (e.g., forklift, hand carts, loading dock types, pallets, cranes, etc.) and a schedule of the equipment availability, employees that can release transportation objects and a schedule of these employees, preferences of the origin location (e.g., preferred transporters, preferred pick up schedules, preferred frequency of order pick up, etc.), inventory delivery schedules, and/or the like. A profile associated with a destination location may have similar information as the profile associated with an origin location.

An inventory profile may be associated with different transportation objects. In other words, each transportation object may have an inventory profile.

Additionally, or alternatively, an inventory profile may include information for multiple different transportation objects. Transportation objects may also be grouped into different groups with each group having an associated inventory profile. Groupings can be made using many different techniques, for example, groupings could be based upon transportation object categories (e.g., household goods, clothing, automotive objects, office products, electronic devices, furniture, user devices, food products, petroleum products, liquid products, gas products, etc.), groupings could be based upon customers (e.g., objects delivered to a single customer are grouped, objects delivered to customers within a particular region or area are grouped, etc.), groupings could be based upon a frequency of deliveries, and/or any other grouping that may be useful.

The inventory profile may include, but is not limited to, information related to transportation objects that are useful for determining a transportation schedule. Thus, the inventory profile may identify locations where inventory of the transportation objects is located (e.g., a warehouse, a manufacturing facility, etc.), identify how much of the transportation object is located at each location, identify when a transportation object will expire (if applicable), identify when a transportation object was placed at a particular location, identify how frequently the transportation object is replenished at a location, and/or the like. Thus, the inventory profile may contain any information that can be utilized to optimize from which origin location the object should be picked up.

The transporter profile may include a schedule of the transporter, regulations applicable to a transporter (e.g., a maximum number of working hours for a predetermined time frame, a required number of rest hours, route restrictions, etc.), whether the transporter works on a team, preferences of the transporter (e.g., preferred origin or delivery locations or regions, preferred load types (e.g., van loads, flatbed loads, tarped loads, less-than-a-load loads, multiple stop loads, etc.), preferred delivery routes, preferred delivery durations, etc.) transportation vehicle specifications, current routes of a transporter, current locations of a transporter, and/or the like. Thus, the transporter profile may include any information that can assist in creating a schedule and route for a particular transportation request.

It should be noted that information stored within a profile can change and may even change in real-time. For example, since a transporter profile may identify information related to when a transporter is available, this information may change as the transporter works, rests, takes vacation, and/or the like. In other words, the schedule of the transporter may be updated as new information is received, which may be in real-time or at particular frequencies. As another example, an inventory profile may change as inventory of a transportation object changes, for example, as inventory is added to a location or removed from a location.

Additionally, it should be noted that the types of information that is stored within the system or accessible to the system is not strictly limited to the types of information that has been discussed as it can be readily understood that other information may be useful and utilized. Thus, the described information is only for illustrative purposes and is not intended to be limiting to only that information described.

Another software component that may be utilized by the system is a database or other data storage location where the system can store information, including historical information, the profile information, current information, and/or the like. The information stored within the data storage location may be stored within a single data lake or data storage location or may be separate data lakes or data storage locations that may be divided by customers, transporters, transportation requests, transportation objects, and/or the like. For example, each customer may have their own data storage location and any historical information related to the customer will be stored within the data storage location of the customer. The historical information can be utilized by the system to determine a schedule for transporting transportation objects.

At 201, the transportation optimization system may receive a transportation request. The transportation request may be transmitted by another system, for example, another system internal to the organization employing the transportation optimization system, another system that is external to the organization employing the transportation optimization system, and/or the like. For example, a company may want to have transportation objects transported to a destination location. This company may then transmit a transportation request to a logistics organization that coordinates the transportation of the transportation object. A transportation object can be any type of product or object that can be transported from one location to another utilizing a transportation vehicle. Thus, transportation objects may include, but are not limited to, furniture, people, petroleum products, gas products, liquid products, food objects, office products, paper products, clothing, household objects, electronics, medical objects, and/or the like. For ease of readability, a transportation object may also be referred to as an object or product. However, these terms are not intended to limit the transportation object in any way.

The transportation request may identify a transportation object, an amount of the transportation object that needs to be transported, and a destination location for the transportation object. The transportation request may identify what object the supplier or customer wants to be transported and how much of the object needs to be transported. Identification of the object may be a simple identification or may include additional specific information, for example, a manufacturer, a lot number, identifiers, and/or the like. Identification of the amount of the object that needs to be transported can be identified using any technique for identifying an amount of the object, for example, a weight, a number amount, a number of pallets of an object, a volume of the object, a bale number, an amount of the object with respect to a transportation vehicle capacity (e.g., half a load, a full load, etc.), and/or the like. How the amount is identified may be based upon the type of the object, for example, a liquid may be identified in weight or volume, whereas a device may be identified in a number or pallet number. In other words, the identification of the amount of the object can be performed using any technique that is used for identifying amounts of objects.

The transportation request may also identify to where the transportation object is to be delivered, which is referred to as the destination location. It should be noted that it is possible to have multiple destination locations for either portions of the same transportation object or for different objects that are on the same transportation vehicle. Multiple destinations for the same transportation vehicles are generally referred to as multi-stop routes. Loads that take up less than the entirety of a transportation vehicle are generally referred to as less-than-a-load (LTL) loads. With these loads, logistic companies often try to add multiple LTL loads together to make a full load for the transportation vehicle. Such LTL loads may require the transportation vehicle to access multiple origin locations, meaning the vehicle may pick up different LTL loads at different origin locations. Alternatively, in the case of the origin location being a warehouse that houses objects from many different suppliers and for many different customers, the vehicle may be able to pick up different LTL loads all at the same origin location.

The transportation request may also include additional information, for example, an origin location, a requested delivery time and/or date, a schedule for the transportation request, a customer associated with the transportation request, an applicable supplier, any requests associated with the transportation request, restrictions associated with the transportation object (e.g., a stacking height, loading type restrictions (e.g., fork lift loading, hand loading, etc.), restrictions against loading with other objects (e.g., cannot be loaded with other food items to maintain Kosher requirements, cannot be loaded with combustible materials, can only be loaded with other products of the same type, cannot be loaded with other loads, etc.), load size restrictions, etc.), load cover requirements (e.g., van or box, tarped, open, chained, etc.), a preferred transportation vehicle type, and/or the like. Some of this information may be used to identify an origin location for the product. For example, an identified customer or supplier may indicate the inventory that can be consumed for the inventory request. As an example, an origin location or multiple origin locations may have the same type of product, for example, a household product. However, not all of the household product may be deliverable to any destination location. Rather, some of the household product may be deliverable to certain types of destination locations, whereas other of the household product may be deliverable to other types of destination locations.

For example, even though the household product may be the same product, some of the household product may be associated with an inventory of Supplier A and other of the household product may be associated with an inventory of Supplier B. Thus, if the transportation request is for a customer of Supplier A, the household product of Supplier B could not be utilized to fulfill the transportation request. This is merely an illustrative example of a situation where a product within a potential origin location could not be used to fulfill the transportation request. It should be readily understood that there are many other situations where inventory at an origin location could not be used to fulfill a transportation request.

To determine if inventory at a potential origin location could be utilized to fulfill a transportation request, the system may utilize the inventory profile as previously described. The inventory profile may identify a supplier or customer associated with the inventory at a particular origin location. The inventory profile may also identify the suppliers or customers that have access to the inventory. In other words, the inventory profile may identify those suppliers or customers who are allowed to request an inventory shipment from or receive products from the inventory at an origin location. Thus, the system may compare the information within the transportation request to the information contained within the inventory profile to determine if the transportation request could be fulfilled from the inventory of a product within an origin location. This comparison may result in an identification of one or more origin locations from which the product could be obtained to fulfill the transportation request.

While information related to the supplier or customer has been described for the comparison, it should be understood that the comparison can occur for any of the information included within the transportation request. For example, as an initial comparison, the system may first identify which origin locations include the object identified in the transportation request. The system may also identify an amount of the object that is located within each origin location. While it may be beneficial to identify those origin locations that have the entire amount of the transportation object in inventory that is identified within the request, the fact that an origin location does not include the entire amount does not preclude that origin location from being utilized to fulfill the transportation request. For example, a transporter could obtain part of the order for the transportation object from one origin location and then obtain the rest of the order for the transportation object from one or more other origin locations.

The schedule or requested delivery date may also be used to preclude or include origin locations as possibilities for the origin location that can be used to fulfill the request. For example, if the transportation object needs to be delivered within twelve hours, origin locations that are outside a twelve-hour radius of the destination location may be precluded from consideration as an origin location to be utilized. However, it should be noted that such locations may be included in view of other factors. For example, if the object is not located at any origin location within an twelve-hour radius, the system may then identify the origin location(s) that are closest to the destination location or from which the object could be delivered the quickest. In such a situation, the system may indicate that selecting such an origin location would result in the requested delivery time not being met and an estimate of the expected delivery time. In other words, while origin locations may be initially precluded from consideration as an origin location, factors may cause the system to subsequently include such origin locations.

When such origin locations are included after an initial preclusion, the system may notify a user of a reason why the origin location was initially precluded. In other words, origin locations can be initially precluded because some portion of the request cannot be fulfilled. Thus, when such origin locations are later included, the system will indicate which part of the request will not be fulfilled by using such an origin location.

It should be noted that origin locations may be initially precluded for any of a variety of reasons, not just for schedule reasons. For example, origin locations may be precluded for a failure to fulfill any of the conditions or information included in the request; based upon restrictions of origin locations, destination locations, transporters, and/or the like; based upon information contained within a customer profile, a transporter profile, and/or the like; restrictions regarding objects included within the transportation request or that are already on a possible transportation vehicle; and/or the like.

At 202, the transportation optimization system determines a schedule for transporting the transportation object to the destination location. The schedule may identify at least one transporter to perform the transporting and may also identify an origin location for the transportation object. The origin location may be one or more origin locations. In other words, the transportation object may be obtained from multiple origin locations, where a portion of the requested amount is obtained from each origin location until the entire requested amount has been obtained. It should also be noted that in order to obtain the desired amount of the transportation object, multiple transportation vehicles could be utilized. Thus, a single transportation vehicle may have a portion of the desired amount of the transportation object, a single transportation vehicle may make multiple stops at origin locations to obtain the desired amount of the transportation object, multiple transportation vehicles may be required to get the entire desired amount of the transportation object from a single origin location, multiple transportation vehicles may be used to get the entire desired amount of the transportation object from multiple origin locations, and/or the like.

It should be noted that the transportation request may include an origin location. However, the transportation optimization system may ignore, when determining the schedule, the origin location included in the transportation request. As previously mentioned, traditional transportation scheduling systems utilize the origin location included in a request and then select the transporter based upon that origin location.

However, this may not be the most efficient or optimized way for getting the transportation object to the desired destination. Accordingly, the described system ignores or deletes the origin location that is included in the request in order to determine which origin location (or locations) results in the most efficient schedule or route for delivering the desired object to the desired destination. In other words, the system ensures that the desired object and amount of the object gets delivered to the desired destination in view of any other appropriate factors (e.g., a desired delivery schedule, load restrictions, other information included in the request, etc.), but understands that any origin location identified within the request may not be the best origin location to actually obtain the object based upon other factors, for example, inventory constraints or factors, transportation constraints or factors, and/or the like. Thus, the system is able to identify which origin location is the best to obtain the object based upon the constraints and factors of the entire logistics supply line and not just an origin location identified in the transportation request.

To determine the schedule, the transportation optimization system may utilize an optimization model, which may include a rules engine, an artificial intelligence model, decision tools, objective function solvers, and/or the like, or a combination thereof. In other words, the term “optimization model” not only includes a traditional optimization model, but also includes any component that can be utilized to optimize the transportation schedule. In the optimization, the system is attempting to identify the most efficient (in terms of time and money) schedule, route, and at least one transporter to transport the desired amount of an object to a destination location while fulfilling one or more constraints including constraints included in the transportation request, transportation constraints, inventory constraints, and any other identified constraints.

Since the schedule is being determined from the perspective of the logistics company, or company that is responsible for getting the object transported to the destination location, the efficiency is identified from a time and money perspective of the logistics company. Thus, time efficiency relates to reducing an amount of time that transporters have to utilize to get the object from an origin location to a destination location. However, such a calculation is more complicated than simply identifying how long a route may take. The transportation of goods is subject to transportation constraints which may include, but are not limited to, transporter regulatory requirements (e.g., routes that transportation vehicles are allowed to take, routes that certain objects are allowed upon, how many hours a transporter can work in a predetermined time period, how many hours a transporter has to rest within a predetermined time period, etc.), current locations of transporters, schedules of transporters (e.g., vacation schedule, working hour schedules, preferred route lengths, a time since last home stay, etc.), destination location constraints (e.g., transportation vehicle constraints, hours that objects can be delivered at the destination location, certain people who have to be present for deliveries, loading dock constraints, whether transportation vehicles can enter the destination location after hours and park, whether transportation vehicles can leave the destination location after hours, any certification requirements, loading/unloading assistance availability and tools, etc.), and/or the like.

Thus, when determining a schedule for a particular route utilizing a particular transporter or transportation vehicle, many different variables come into play, which can result in many different schedules even if the origin location, the origin location start time, and the destination location are exactly the same for different transporters. For example, due to a number of hours that a transporter has already driven in the previous seven day period, one transporter may be able to make the delivery to the destination location in less time than another transporter even starting at the same time from the same origin location. Other factors that come into play when optimizing a schedule include a current location of potential transporters. For example, if a transporter has to travel a further distance to get to the origin location as compared to another transporter with an empty trailer or transportation vehicle (referred to as deadheading), then the cost of the transporter who has to deadhead for a further distance is higher than the transporter who has to deadhead for a shorter distance.

However, if the transporter who has to travel the further distance is already completing a route that takes them near the origin location, then it may be more cost effective to have that transporter obtain the transportation object at the origin location than to have a transporter deadhead to the origin location, if the transporter who is already performing a route has the space on the transportation vehicle and if the current route schedule allows the time to obtain the transportation object. However, if the current route schedule does not allow the time to obtain the transportation object, then it may not be more cost effective to have that transporter obtain the transportation object even though the transporter will be near the origin location.

As can be understood, even with this relatively simple example, the calculus for determining which transporter should be utilized to obtain the transportation object can get very complex. This very simple example only takes into account a few factors that are related to the transporter and does not even start to take into account the fact that different origin locations can be selected, any destination location constraints, any other transportation constraints, inventory constraints, and/or the like. Thus, as can be readily understood, the calculus that can be utilized to take into account all of the factors and constraints in determining a schedule becomes very complex. Traditional techniques simply identify the transporters who are assigned to a region associated with a previously identified origin location and which transporters are currently available, are closest to the origin location, and that can reach the destination location at or before the requested delivery time. Thus, such traditional techniques are not very efficient and are unable to optimize the schedule and select an origin location.

Another factor that may come into play when optimizing the schedule may include transportation requests that may be near a destination location or schedules for a transporter that occur after the objects are off-loaded at the destination location. For example, if there is another transportation request that has a potential origin location near the destination location, it may be more efficient to select an origin location for the current transportation request and a transporter that would allow for the transporter the ability to obtain the objects for the subsequent transportation request. As an example, it may be more efficient for transporter A to obtain and delivery the objects for the current transportation request as compared to transporter B. However, transporter A may be out of hours after this transport and may be unable to obtain the objects for the subsequent transportation request and deliver them to the destination location. Transporter B, however, may have the requisite number of hours to perform both transportation requests. Thus, it may become more efficient to assign both requests to transporter B instead of the first request to transporter A and then the second request to a different transporter. Again, as can be readily understood this is a very simple example that only focuses on a single factor and an example that focuses on all possible factors and constraints and possible transporters and transportation vehicles will become particularly complex, particularly when different origin locations could be utilized.

Other factors that can be taken into account include inventory constraints. Inventory constraints may include origin location constraints (e.g., hours of operation, hours allowed for pick up, allowed transportation vehicle types, loading/unloading assistance and tools, etc.), an inventory amount of the object within a particular origin location, a length of time the transportation object has been within an origin location, a location of an origin location with respect to a transporter, transportation object transportation requirements (e.g., whether the object can be loaded with other objects and what types of objects, whether the object needs a particular transportation vehicle type, whether the object has loading or transport requirements, whether the object has to be verified or locked on the transportation vehicle, etc.), and/or the like. As an example, if a transportation object is perishable or has an expiration date, there may be cost incentive to transport the objects located at a first origin location that are expiring or perishing the soonest as compared to the objects located at a second origin location that are expiring or perishing later, even if the first origin location is further or less cost effective from a route perspective as compared to the second origin location.

As another example, if a first origin location does not have the entirety of the amount needed for the transportation request it may be more cost effective to obtain the object from a second origin location that does have the entirety of the amount needed for the request even if the second origin location is further from the destination location. On the other hand, if a third origin location has an amount of the object that would fulfill the request when used in conjunction with the amount at the first origin location, it may become more efficient to utilize the amount at the first location and the third location, particularly if the third location is along or near the route that the transporter needs to travel to get to the destination location. Alternatively, the first and third location may be more efficient than the second location if another transporter can obtain the object at the third location and meet the transporter of the first location at the destination location.

This may occur if the another transporter is already at the third origin location, is already heading to the destination location, has a route that takes them near the third origin location and the destination location, and/or the like. In other words, like the transportation constraints, the inventory constraints can make the calculus for determining a schedule very complex.

Accordingly, the system utilizes the optimization model to perform the computations associated with determining the schedule. The optimization model is able to receive as inputs all of the transportation constraints, the inventory constraints, the information contained with the request, and the information contained within the profiles. With the optimization being directed towards money and time from the perspective of the logistics company, the optimization model can analyze the inputs against possible permutations or solutions to the problem based upon the inputs. In other words, the system can create possible solutions based upon the inputs and in view of optimizing the money and time spent for each of the solutions. The solutions take into account the constraints and other inputs, meaning that the solutions are intended to fulfill the constraints and other information within the provided inputs.

In some cases, some of the constraints included in the inputs may be unable to be fulfilled. In such a case, the system may identify the solutions that fulfill the most inputs or the inputs having higher weightings than others. When providing the outputs to the user, the system may identify which inputs were unable to be fulfilled. The user may also provide an indication, for example, through historical input, manual input, input through a profile, default input, and/or the like, of a weighting or preference of inputs that need to be fulfilled. For example, a user may indicate that transportation requests may have a higher weight than transporter constraints. As another example, a user may indicate that a requested delivery date and time has a higher weight than a requested transportation vehicle type. Some inputs may not have weightings and may be treated the same as other inputs. Thus, if a user has inputs that need to be weighted higher or lower than others, the user does not have to provide weightings for each individual input, but, instead, can provide weightings to only those identified inputs.

Each of the solutions may be assigned a time and/or money value. The system can then determine which solutions have the lowest time and/or money value assigned to them. Each of the solutions have associated outputs that allow a user to implement the solution. In other words, the outputs include the information that the user needs to know to implement the solution. The system may present only those solutions which have the lowest time and/or money value assigned to them, may present a subset of the solutions (e.g., a predetermined number of solutions, all solutions fulfilling the inputs, a predetermined percentage of the solutions, etc.), and/or the like. The system may present a certain number of solutions and the user could provide an input to the system to provide more of the solutions. It should be noted that transportation requests having the same destination location, same transportation object, and same amount of the transportation object may result in different solutions at different times. For example, when the transportation request is received at one time, the best solution may be obtaining the object from origin location A, whereas when a similar transportation request is received at a different time, the best solution may be obtaining the object from original location B. In other words, simply because one solution was presented at one time, this does not mean that the same solution will be the optimal solution at a later time.

As output, the optimization model provides the schedule for transporting the transportation object. The schedule identifies a transporter to be used to perform the transporting and also identifies the origin location (or locations) from which the amount of the object (or portions of the desired amount of the object) should be obtained. As previously noted, the transportation objects could be located at more than one origin location. Thus, one of the outputs provided by the system is an identification of which origin location (or locations, if applicable) the objects should be obtained from. Thus, instead of relying on the origin location included in the transportation request, if included, the system identifies the origin location that results in the most efficient or optimized schedule.

In addition to this information, the optimization model may also provide other outputs. For example, the schedule may also identify a route that the transporter should take between the identified origin location and the destination location. The route may also identify a route the transporter should utilize to get to the origin location and may include a route the transporter should utilize to get to a subsequent origin location for a subsequent transportation request. In the event that the transportation object results in an LTL load, the route may also include route information for obtaining other transportation objects along the route to the destination location, obtaining other transportation objects that go to the same destination location, obtaining other transportation objects at the origin location that go to other destination locations, routes to other destination locations related to transportation objects on the transportation vehicles, and/or any other route information. For example, the identification of a route may include identifying at least one other transportation object to be obtained by the transporter on the transportation vehicle (either before or after the current transportation object has been delivered), identifying a second origin location to obtain that at least one other transportation object, and a destination location for the at least one other transportation object.

The schedule may also identify a time for when the at least one transporter is to obtain the transportation object from the at least one origin location based upon the inventory constraints, for example, the origin destination location constraints. To identify the time, the optimization model may take into account the inventory and transportation constraints that are related to time (e.g., pick up time constraints, delivery time constraints, transporter time constraints, transporter schedule, etc.). Additionally, the system may calculate a duration of the transporting based upon the transportation constraints. In other words, the system may determine how long the route will take to traverse while taking into account allowed driving time lengths, required rest time lengths, fuel stops, and/or the like, that will add time to a route.

Thus, based upon when the objects are requested to be at the destination location, a determined window of time that the objects can be delivered at the destination location as identified from the transportation constraints, a determined window of time that the objects can be obtained from the origin location, and the duration of the route, the system can identify when the objects should be obtained at the origin location (or locations). In other words, the system can determine when the objects should be obtained from the origin location to result in the least amount of time that the transporter would need to spend sitting and waiting to delivery the objects. This computation could be performed using an optimization model, which could be the same model or a different model, having the mentioned inputs and that solves for outputs with dead time (i.e., time that the transporter is just sitting and waiting) being the optimization factor.

From the solutions, the system may generate a transportation order at 203. The transportation order identifies the amount of the transportation object, the destination location, and the schedule. Thus, the transportation order can include any information that is output with the schedule, including the route, a pick up time, an indication of the origin location, and/or the like. The transportation order can include any information that would be needed by a transporter to actually perform the transporting of the transportation object. When generating the transportation order, the system may automatically generate the transportation order from the highest ranked solution or solution having the lowest time and/or money value associated with it.

Alternatively, the system may generate the transportation order after receiving an input from a user. The system may present one or more of the solutions to a user. The user may then select the solution that should be implemented. From this selection, the system may generate the transportation order. In other words, before generating the transportation order, the system may require user input. Whether the system needs user input or not may be based upon preferences of the user, may be a default setting, may be based upon user preferences for certain types of transportation requests (e.g., orders for certain customers can be automatically generated, orders for certain objects can be automatically generated, orders having a duration under a certain time frame can be automatically generated, etc.), and/or the like.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment.

Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated. Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, the method comprising:
receiving a transportation request, wherein the transportation request identifies a transportation object, an amount of the transportation object that needs transported, and a destination location for the transportation object;
determining, using an optimization model and based upon transportation constraints and inventory constraints, a schedule for transporting the transportation object to the destination location, wherein the schedule identifies at least one transporter to perform the transporting and identifies at least one origin location for the transportation object, wherein the at least one origin location is identified using the optimization model that identifies an origin location resulting in a schedule that fulfills the transportation constraints and inventory constraints for delivering the transportation object to the destination location;
generating a transportation order comprising the amount of the transportation object, the destination location, and the schedule; and
presenting the transportation order to a user.

2. The method of claim 1, wherein a plurality of origin locations contains the transportation object, wherein the at least one origin location is selected from the plurality of origin locations.

3. The method of claim 1, wherein the transportation constraints comprise at least one constraint selected from the group consisting of: transporter regulatory requirements, transporter location, transporter schedule, and destination location constraints.

4. The method of claim 1, wherein the inventory constraints comprise at least one constraint selected from the group consisting of: origin location constraints, an inventory amount of the transportation object within an origin location, a length of time the transportation object has been within an origin location, a location of an origin location with respect to a transporter, and transportation object transportation requirements.

5. The method of claim 1, wherein the optimization model comprises an artificial intelligence model.

6. The method of claim 1, wherein the determining a schedule comprises identifying a route for the at least one transporter from the at least one origin location to the destination.

7. The method of claim 6, wherein the identifying a route comprises identifying at least one other transportation object and a second origin location for the at least one other transportation object to be obtained by the at least one transporter within the route.

8. The method of claim 1, wherein the determining a schedule comprises identifying a time for the at least one transporter to obtain the transportation object from the at least one origin location based upon the inventory constraints.

9. The method of claim 8, where the identifying a time comprises calculating a duration of the transporting based upon the transportation constraints, determining a window of time for delivering the transportation object to the destination location based upon the transportation constraints, and identifying the time based upon the duration and the window of time.

10. The method of claim 1, wherein the transportation request comprises an origin location and wherein the determining a schedule comprises ignoring the origin location within the transportation request.

11. A system, the system comprising:
a processor;
a memory device that stores instructions that, when executed by the processor, causes the system to:
receive a transportation request, wherein the transportation request identifies a transportation object, an amount of the transportation object that needs transported, and a destination location for the transportation object;
determine, using an optimization model and based upon transportation constraints and inventory constraints, a schedule for transporting the transportation object to the destination location, wherein the schedule identifies at least one transporter to perform the transporting and identifies at least one origin location for the transportation object, wherein the at least one origin location is identified using the optimization model that identifies an origin location resulting in a schedule that fulfills the transportation constraints and inventory constraints for delivering the transportation object to the destination location;
generate a transportation order comprising the amount of the transportation object, the destination location, and the schedule; and
present the transportation order to a user.

12. The system of claim 11, wherein a plurality of origin locations contains the transportation object, wherein the at least one origin location is selected from the plurality of origin locations.

13. The system of claim 11, wherein the transportation constraints comprise at least one constraint selected from the group consisting of: transporter regulatory requirements, transporter location, transporter schedule, and destination location constraints.

14. The system of claim 11, wherein the inventory constraints comprise at least one constraint selected from the group consisting of: origin location constraints, an inventory amount of the transportation object within an origin location, a location of an origin location with respect to a transporter, and transportation object transportation requirements.

15. The system of claim 11, wherein the optimization model comprises an artificial intelligence model.

16. The system of claim 11, wherein the determining a schedule comprises identifying a route for the at least one transporter from the at least one origin location to the destination.

17. The system of claim 16, wherein the identifying a route comprises identifying at least one other transportation object and a second origin location for the at least one other transportation object to be obtained by the at least one transporter within the route.

18. The system of claim 11, wherein the determining a schedule comprises identifying a time for the at least one transporter to obtain the transportation object from the at least one origin location based upon the inventory constraints.

19. The system of claim 18, where the identifying a time comprises calculating a duration of the transporting based upon the transportation constraints, determining a window of time for delivering the transportation object to the destination location based upon the transportation constraints, and identifying the time based upon the duration and the window of time.

20. A product, the product comprising:
a non-transitory computer-readable storage device that stores executable code that, when executed by a processor, causes the product to:
receive a transportation request, wherein the transportation request identifies a transportation object, an amount of the transportation object that needs transported, and a destination location for the transportation object;
determine, using an optimization model and based upon transportation constraints and inventory constraints, a schedule for transporting the transportation object to the destination location, wherein the schedule identifies at least one transporter to perform the transporting and identifies at least one origin location for the transportation object, wherein the at least one origin location is identified using the optimization model that identifies an origin location resulting in a schedule that fulfills the transportation constraints and inventory constraints for delivering the transportation object to the destination location;
generate a transportation order comprising the amount of the transportation object, the destination location, and the schedule; and
present the transportation order to a user.
